(19) United States
(12) Patent Application Publication
(10) Pub. No.: US 2009/0018860 A1
(43) Pub. Date: Jan. 15, 2009

(54) METHOD AND COMPUTER PROGRAM FOR BACK OFFICE CHECK CONVERSION

(76) Inventors: Joel Edward Sikes, Overland Park, KS (US); Gilbert H. Anderson, Overland Park, KS (US); Richard Wesley Palmer, Parkville, MO (US); Steven Rob Bryer, Olathe, KS (US)

Correspondence Address: SPENCER, FANE, BRITT & BROWNE, 1000 WALNUT STREET, SUITE 1400, KANSAS CITY, MO, 64106-2140, US

(21) Appl. No.: 11/971,000

(22) Filed: Jan. 8, 2008

Related U.S. Application Data
(60) Provisional application No. 60/883,854, filed on Jan. 8, 2007.

(51) Int. Cl. G06Q 10/00; G06F 17/30

(52) U.S. Cl. 705/1; 707/3; 707/E17.014

(57) ABSTRACT

A method and computer program for facilitating back office check conversion in a retail establishment, such as during reconciliation of cash drawers. The method broadly includes the steps of retrieving first check data from a point of sale system; imaging the check to capture second check data; comparing the first and second check data to confirm that they are substantially identical; determining whether the check is eligible for automated processing; and, if so, adding the image of the check to an electronic file for subsequent transmission of the check data to a financial institution. The method may also include allowing for scheduling automatic resubmission of a returned check. The method may also include maintaining a database of the check data, and allowing for accessing and searching the database for particular check data via an electronic network.

### RELATED APPLICATIONS

The present U.S. non-provisional patent application is related to and claims priority benefit of an earlier-filed U.S. provisional patent application of the same title, Ser. No. 60/883,854, filed Jan. 8, 2007. The identified earlier-filed application is hereby incorporated by reference into the present application as though fully set forth herein.

### FIELD OF THE INVENTION

The present invention relates broadly to methods and computer programs for check processing. More specifically, the present invention concerns a method and computer program for facilitating back office check conversion in a retail establishment, such as during reconciliation of cash drawers, wherein the method broadly involves imaging a check, comparing check data from a point of sale terminal with check data captured by the imaging device, and determining whether the check is eligible for processing.

### BACKGROUND OF THE INVENTION

Many retail establishments accept checks in payment of goods or services. Unfortunately for the retailers, checks are expensive and time-consuming to process. Furthermore, it can take three to four days or more after submitting checks to the retailers' banks before the checks settle and the retailers are credited the check amounts to their accounts. This delay is due in part to a presentment delay, which is the time required to physically deliver the checks to the banks, and in part to a funds availability delay, which is the time required by the banks, after receiving delivery of the checks, to make the funds available to the retailers. The presentment delay is always at least one day and is generally longer, depending on how often couriers are scheduled to pick-up and transport the checks to the banks. The funds availability delay is generally one to two days. During this delay, the retailers are, in effect, loaning the purchase amounts, without interest, to the consumers.

Systems exist for converting paper checks to automated clearing house payments at the point of sale (POS), but these have not been widely accepted because they require that customers give written authorization (in addition to signing the check) and require that imaging devices be installed at every POS terminal.

### SUMMARY OF THE INVENTION

The present invention addresses the above-identified and other problems and limitations by providing a method and a computer program stored on a computer readable medium for facilitating back office check conversion in a retail establishment, such as during reconciliation of cash drawers.

In one embodiment, the method broadly comprises the steps of electronically retrieving first check data from a point of sale system; imaging the check using an imaging device to capture second check data; comparing the first check data and the second check data to confirm that they are substantially identical; determining whether the check is eligible for automated processing; and, if the check is eligible for automated processing, adding the image of the check to an electronic file for subsequent transmission of the check data to a financial institution.

In various embodiments, the present invention may further include one or more of the following additional features. The check data may include magnetic ink character recognition line data. The check data may include a routing number, an account number, a check serial number, and a dollar amount. The method may include the additional step of receiving from the financial institution an electronic acknowledgement of receipt of the check data. The method may include the additional step of allowing for scheduling automatic resubmission of a returned check, wherein automatic resubmission may occur after a specified number of days or may occur at a specified time of the month. The method may include the additional steps of maintaining an electronic database of the check data, and allowing for accessing and searching the electronic database for particular check data via an electronic network.

The method may be implemented electronically by a computer program comprising one or more code segments stored on a computer-readable medium and executable by a computing device.

These and other features of the present invention are described in greater detail below in the section titled DETAILED DESCRIPTION.

### BRIEF DESCRIPTION OF THE DRAWING FIGURES

The present invention is described herein with reference to the following drawing FIGURE:

FIG. 1 is a flowchart of steps involved in practicing the method of the present invention.

### GLOSSARY

The present invention is described herein using the following acronyms:

ACH “automated clearing house”.
BOC “back office conversion”.
IRD “image replacement document”.
MICR “magnetic ink character recognition”.

### NACHA “National Automated Clearing House Association”.

POP “point of purchase”.
POS “point of sale”.

### DETAILED DESCRIPTION

With reference to the drawing FIGURE, a method and computer program are herein described, shown, and otherwise disclosed in accordance with various embodiments, including a preferred embodiment, of the present invention. Broadly, the present invention concerns a method and a computer program stored on a computer readable medium for facilitating back office check conversion in a retail establishment, such as during reconciliation of cash drawers.

The “Check Clearing for the 21st Century Act”, or “Check 21”, encourages financial institutions to exchange digital images of checks rather than the original paper checks. The Act also gives substitute checks, called image replacement documents (IRDs), printed from these digital images the same legal status as the original paper checks, so that financial institutions unwilling to accept digital images receive IRDs instead. Among other advantages, this will save significant time and money spent processing paper checks; at one point, for example, it cost the Federal Reserve 4.5 cents to process a paper check, but it costs only 1.3 cents to process an automated clearing house (ACH) payment. The ACH network is a nationwide system for electronically transferring funds, and allows participating financial institutions to quickly and efficiently clear electronic payments.

Back office conversion (BOC) allows retailers to convert paper checks to ACH entries in the back office environment rather than at the point of sale (POS) terminal, thereby providing the benefits of reduced cost and risk without prolonging tender time or requiring costly hardware at every POS terminal. Instead of encoding checks for subsequent physical deposit, the checks are imaged for electronic presentment to the bank.

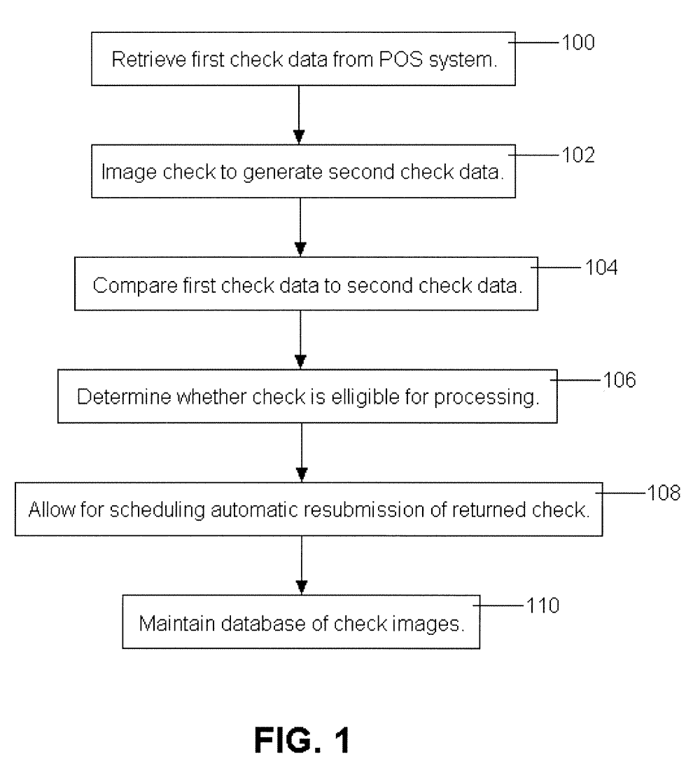

Referring to FIG. 1, in one embodiment, the method of the present invention may be practiced during reconciliation of cash drawers. For each check, a computer program for managing cash drawers, such as the VeriBalance™ program by Balance Innovations, LLC, retrieves magnetic ink character recognition (MICR) data, including the routing number, account number, check serial number, and dollar amount, from the POS system, as shown in box 100. The paper check is imaged by back office personnel using an imaging/scanning device to independently capture the MICR data, as shown in box 102. In an alternative embodiment, the check is imaged by the cashier using an imaging/scanning device at the POS terminal. The MICR data from the POS terminal is compared with the MICR data independently generated by the imaging operation, as shown in box 104. Additionally, the courtesy and legal dollar amounts shown on the check may be compared with the POS dollar amount; CAR-LAR (“Courtesy Amount Recognition—Legal Amount Recognition”) software is available to facilitate this particular comparison. Relatedly, where POS data is not available for comparison with the imaged data, the CAR-LAR software may be used to determine whether the image is of sufficient quality for use.

If the two data sets differ, the back office personnel are notified. Based upon the confirmed MICR data, a determination is made as to whether the check is eligible for processing, using, for example, ACH, Check 21, image exchange, or other processing, or whether an IRD needs to be sent to deposit the check because the check does not meet NACHA guidelines for BOC conversion, as shown in box 106. More specifically, only consumer checks can be processed through BOC ACH; ineligible checks include checks drawn on business accounts, third-party checks, demand drafts without signatures, credit card checks, bank drafts (i.e., money orders, certified checks, and traveler's checks), government checks, and checks not payable in U.S. currency. If the check is eligible, it is added to a BOC file for subsequent transmittal to the bank. Thereafter, the retailer receives a settlement report to verify deposits and returns.

It will be appreciated that occasionally checks are returned as being non-payable for some reason, often because there are insufficient funds in the check writer's account to cover the amount of the check. In one embodiment of the present invention, the retailer can schedule automatic resubmission of the returned checks after a specified number of days, e.g., ten days, after the check is returned or at a specified time each month, e.g., the first or the fifteenth day of the month, as shown in box 108. It will be appreciated that expedited re-presentment can significantly reduce losses from returned checks. This feature is further facilitated by the fact that checks processed using BOC are generally returned in two to four days, while paper checks processed conventionally are generally not returned for seven to ten days. In one embodiment, if, after resubmission, the check is collected, then a separate transaction is initiated to collect the fee the retailer charges for returned checks.

It will also be appreciated that occasionally customers dispute check charges. In one embodiment, a database of the check images is maintained locally by the retailer, while, in another embodiment, the database is maintained remotely by a third-party for the benefit of the retailer. Advantages of the latter embodiment include storage capacity advantages, efficiencies of scale advantages, and security advantages. In one implementation, the retailer can access the database via a secure network portal using encrypted SQL. The retailer can search the database by a relevant search criterion, such as amount, account, store, or date, as shown in box 110. In addition to quickly and easily identifying and providing check data for addressing disputes, the database also allows for destroying the original paper checks after a specified period of time while still maintaining the relevant check data. Similarly, electronic entries in the database can be automatically deleted after a specified period of time, which, in one implementation, may be specified by each store.

Thus, it will be appreciated that the present invention can reduce check processing costs, including check clearing fees and surcharges for special handling of, e.g., unencoded or otherwise rejected checks; accelerate access to payments (one to two days rather than three to four or more days) and thereby reduce float costs; and reduce losses though an expedited electronic process for handling returned checks. Additionally, the present invention can reduce courier costs associated with transporting paper checks to banks, and some labor costs associated with processing and handling paper checks.

The above-described method can be implemented electronically by a computer program comprising one or more code segments stored on a computer-readable medium and executable by a computing device.

Although the invention has been disclosed with reference to various particular embodiments, it is understood that equivalents may be employed and substitutions made herein without departing from the scope of the invention.

Having thus described a preferred embodiment of the invention, what is claimed as new and desired to be protected by Letters Patent includes the following:

1. A method of facilitating back office check conversion in a retail establishment, the method comprising the steps of:
electronically retrieving first check data from a point of sale system;
imaging the check using an imaging device to capture second check data;
comparing the first check data and the second check data to confirm that they are substantially identical;
determining whether the check is eligible for automated processing; and
if the check is eligible for automated processing, adding the image of the check to an electronic file for subsequent transmission of the check data to a financial institution.

2. The method as set forth in claim 1, wherein the check data includes magnetic ink character recognition line data.

3. The method as set forth in claim 1, wherein the check data includes a routing number, an account number, a check serial number, and a dollar amount.

4. The method as set forth in claim 1, further including the step of receiving from the financial institution an electronic acknowledgement of receipt of the check data.

5. The method as set forth in claim 1, further including the step of allowing for scheduling automatic resubmission of a returned check.

6. The method as set forth in claim 5, wherein automatic resubmission occurs after a specified number of days.

7. The method as set forth in claim 5, wherein automatic resubmission occurs at a specified time of the month.

8. The method as set forth in claim 1, further including the steps of—
maintaining an electronic database of the check data; and
allowing for accessing and searching the electronic database for particular check data via an electronic network.

9. A method of facilitating back office check conversion in a retail establishment, the method comprising the steps of:
electronically retrieving first check data from a point of sale system;
imaging the check using an imaging device to capture second check data,
wherein the first check data and the second check data both include magnetic ink character recognition line data including a routing number, an account number, a check serial number, and a dollar amount;
comparing the first check data and the second check data to confirm that they are substantially identical;
determining whether the check is eligible for automated processing;
if the check is eligible for automated processing, adding the image of the check to an electronic file for subsequent transmission of the check data to a financial institution;
receiving from the financial institution an electronic acknowledgement of receipt of the check data;
maintaining a database of the check data at a remote location; and
allowing for accessing and searching the database for particular check data via an electronic network.

10. The method as set forth in claim 9, further including the step of allowing for scheduling automatic resubmission of a returned check.

11. The method as set forth in claim 10, wherein automatic resubmission occurs after a specified number of days.

12. The method as set forth in claim 10, wherein automatic resubmission occurs at a specified time of the month.

13. A method of facilitating back office check conversion in a retail establishment, the method comprising the steps of:
electronically retrieving first check data from a point of sale system;
imaging the check using an imaging device to capture second check data,
wherein the first check data and the second check data both include magnetic ink character recognition line data including a routing number, an account number, a check serial number, and a dollar amount;
comparing the first check data and the second check data to confirm that they are substantially identical;
determining whether the check is eligible for automated processing;
if the check is eligible for automated processing, adding the image of the check to an electronic file for subsequent transmission of the check data to a financial institution;
if the check is returned, allowing for scheduling automatic resubmission of the returned check to the financial institution;
maintaining a database of the check data at a remote location; and
allowing for accessing and searching the database for particular check data via an electronic network.

14. The method as set forth in claim 13, wherein automatic resubmission occurs after a specified number of days.

15. The method as set forth in claim 13, wherein automatic resubmission occurs at a specified time of the month.

16. The method as set forth in claim 13, further including the step of receiving from the financial institution an electronic acknowledgement of receipt of the check data.

17. A computer program for facilitating back office check conversion in a retail establishment, with the computer program being stored on a computer-readable medium and executable by a computing device, the computer program comprising:
a code segment operable to electronically retrieve first check data from a point of sale system;
a code segment operable to receive a captured image of the check containing second check data;
a code segment operable to compare the first check data and the second check data to confirm that they are substantially identical;
a code segment operable to determine whether the check is eligible for automated processing; and
a code segment operable to add the image of the check to an electronic file for subsequent transmission of the check data to a financial institution, if the check is eligible for automated processing,

18. The computer program as set forth in claim 17, wherein the check data includes magnetic ink character recognition line data.

19. The computer program as set forth in claim 17, wherein the check data includes a routing number, an account number, a check serial number, and a dollar amount.

20. The computer program as set forth in claim 17, further including a code segment operable to receive from the financial institution an electronic acknowledgement of receipt of the check data.

21. The computer program as set forth in claim 17, further including a code segment operable to allow for scheduling automatic resubmission of a returned check.

22. The computer program as set forth in claim 21, wherein automatic resubmission occurs after a specified number of days.

23. The computer program as set forth in claim 21, wherein automatic resubmission occurs at a specified time of the month.

24. The computer program as set forth in claim 1, further including a code segment operable to allow for accessing and searching an electronic database containing the check data for particular check data via an electronic network.

25. A computer-readable medium encoded with a computer program for facilitating back office check conversion in a retail establishment, wherein the computer program is executable by a computing device, the computer program comprising:
a code segment operable to electronically retrieve first check data from a point of sale system;
a code segment operable to receive a captured image of the check containing second check data;
a code segment operable to compare the first check data and the second check data to confirm that they are substantially identical;
a code segment operable to determine whether the check is eligible for automated processing; and
a code segment operable to add the image of the check to an electronic file for subsequent transmission of the check data to a financial institution, if the check is eligible for automated processing,

26. The computer-readable medium as set forth in claim 25, wherein the check data includes magnetic ink character recognition line data.

27. The computer-readable medium as set forth in claim 25, wherein the check data includes a routing number, an account number, a check serial number, and a dollar amount.

28. The computer-readable medium as set forth in claim 25, wherein the computer program further includes a code segment operable to receive from the financial institution an electronic acknowledgement of receipt of the check data.

29. The computer-readable medium as set forth in claim 25, wherein the computer program further includes a code segment operable to allow for scheduling automatic resubmission of a returned check.

30. The computer-readable medium as set forth in claim 29, wherein automatic resubmission occurs after a specified number of days.

31. The computer-readable medium as set forth in claim 29, wherein automatic resubmission occurs at a specified time of the month.

32. The computer-readable medium as set forth in claim 25, wherein the computer program further includes a code segment operable to allow for accessing and searching an electronic database containing the check data for particular check data via an electronic network.
